(19) United States
(12) Patent Application Publication
(10) Pub. No.: US 2013/0166643 A1
(43) Pub. Date: Jun. 27, 2013

(54) Systems and Methods for Online Ad Hoc Matching

(71) Applicant: Joseph Essas, Los Angeles, CA (US)

(72) Inventor: Joseph Essas, Los Angeles, CA (US)

(21) Appl. No.: 13/335,773

(22) Filed: Dec. 22, 2011

(51) Int. Cl. G06F 15/16

(52) U.S. Cl. 709/204

(57) ABSTRACT

The invention is generally directed to systems and methods for operation of a match service, and more particularly to systems and methods that enable online ad hoc matching between two or more subscribers. If a first subscriber to a match service identifies a second subscriber, in a preferred embodiment, the first subscriber can obtain the second subscriber's electronic match profile data and initiate an ad hoc compatibility analysis to assess compatibility.

### FIELD OF THE INVENTION

The field of the invention relates to systems and methods for operation of a matching service, and more particularly to systems and methods that enable online ad hoc matching.

### BACKGROUND OF THE INVENTION

Research has shown that the success of human interpersonal relationships depends on complex interactions between a large number of variables including, but not limited to, personality, socioeconomic status, religion, appearance, ethnic background, energy level, education, interests and appearance. Matching services have developed effective systems that analyze these variables to identify and match people who have the potential to establish a successful relationship. A well-known example of such a service is eHarmony, Inc. (which can be found at www.eharmony.com). A matching service generally collects and stores data to create a “profile” for each subscriber. The profile includes a number of factors potentially relevant to establishing a successful interpersonal relationship with that subscriber. The matching service then correlates that subscriber's profile with others in its database to assess which profiles are compatible, i.e., which subscribers have the potential for a successful relationship when matched.

Many of these matching services are focused on long-term social commitments, such as marriage. Moreover, for these matching services, after a subscriber establishes a profile, the subscriber then relies on the service to provide the subscriber possible matches. Accordingly, alternative systems and methods for facilitating interpersonal relationships may be desirable.

### SUMMARY OF THE INVENTION

The invention is generally directed to systems and methods for operation of a matching service, and more particularly to systems and methods that enable online ad hoc matching. If a first subscriber to a match service identifies a second subscriber, the first subscriber can obtain the second subscriber's match profile data and initiate an ad hoc compatibility analysis to assess compatibility.

One preferred embodiment is a computer-based system for enabling an ad hoc interpersonal relationship analysis. The system includes a source computing device, operatively coupled to a public network, having a first match profile identification associated with said first computing device's user and a target computing device, operatively coupled to the public network, having a second match profile identification associated with said target computing device's user. The system further includes a matching server system, operatively coupled to the public network, having a database that stores match profile data associated with the first and second match profile identifications. The source computing device is configured to retrieve the second match profile identification from the target computing device and transmit the first and second match profile identifications to the matching server system via the public network. Further, the matching server system is configured to receive the first and second match profile identifications via the public network from the source computing device, query and correlate the match profile data associated with the first and second match profile identifications, compute one or more compatibility values from the correlation of the match profiles associated with the least two match profiles identifications, and transmit said compatibility value to the source computing device via said public network.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1a is an exemplary diagram of an online ad hoc matching system in accordance with a preferred embodiment of the present invention;

FIG. 1b is an exemplary diagram of a matching system server in accordance with a preferred embodiment of the present invention.

FIG. 1c is an exemplary diagram of a subscriber's computing device in accordance with a preferred embodiment of the present invention.

FIG. 2 is an exemplary flowchart of a process in accordance with a preferred embodiment of the present invention.

FIG. 3 is an exemplary flowchart of another process in accordance with a preferred embodiment of the present invention.

FIG. 4 is an exemplary flowchart of another process in accordance with a preferred embodiment of the present invention.

FIG. 5a is an exemplary user interface in accordance with a preferred embodiment of the present invention.

FIG. 5b is another exemplary user interface in accordance with a preferred embodiment of the present invention.

### DETAILED DESCRIPTION OF THE PREFERRED EMBODIMENTS

### Preferred Systems

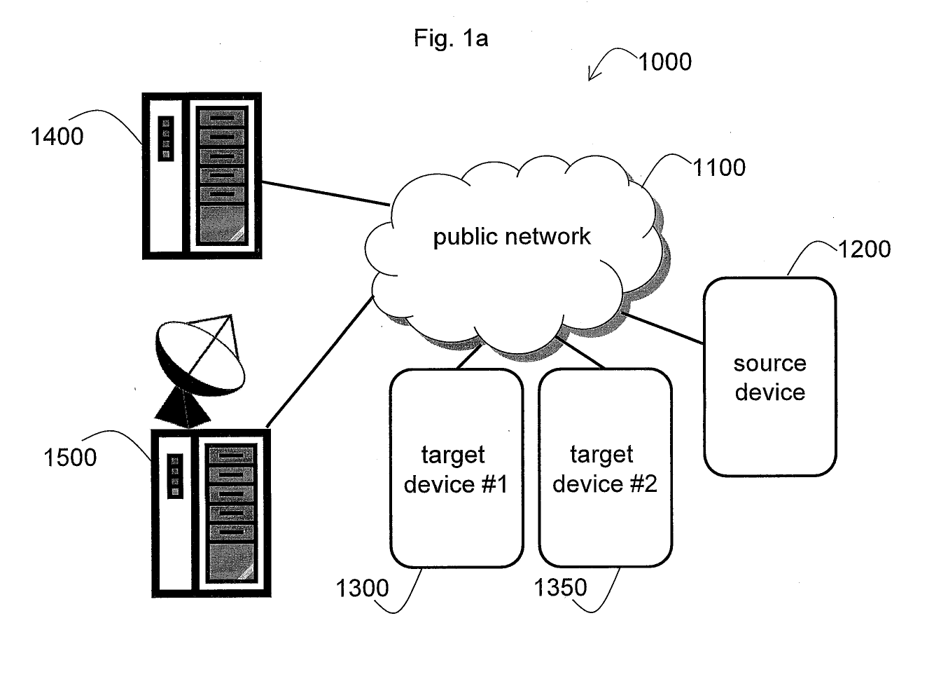

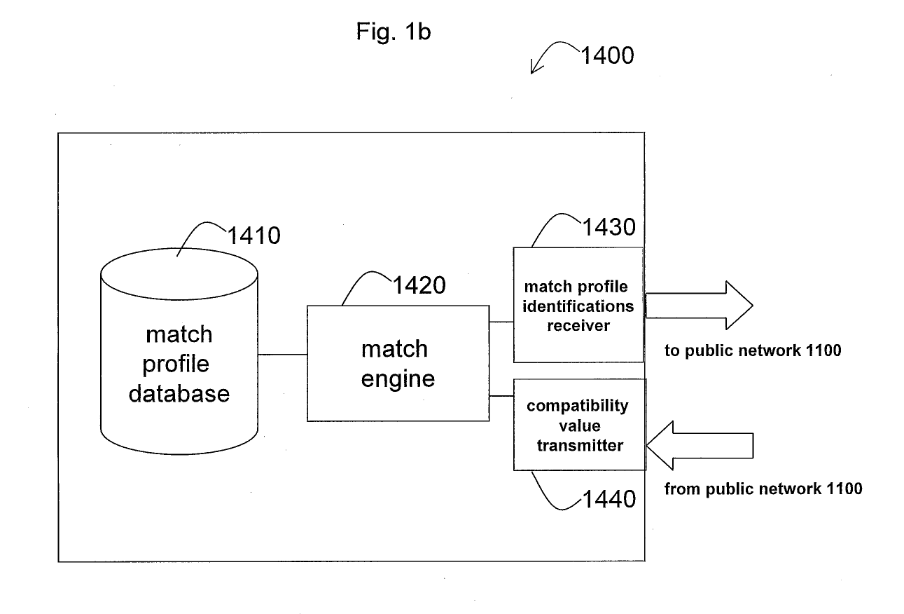

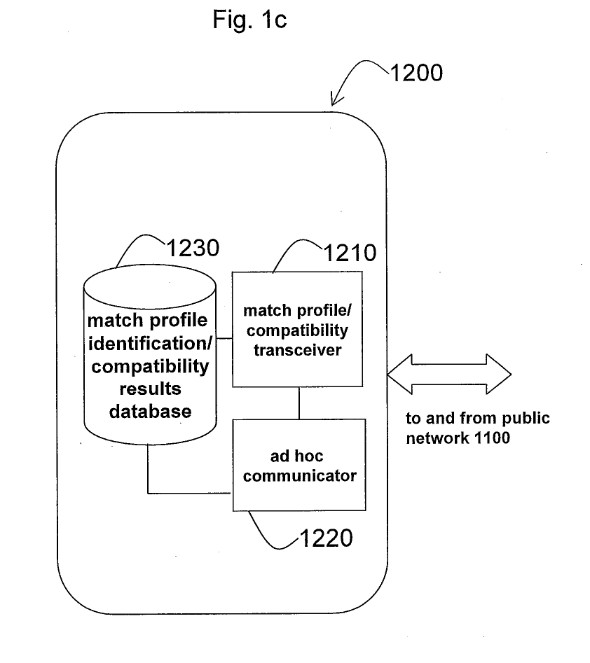

Turning to FIG. 1a, an ad hoc computer-based matching system 1000 in accordance with a preferred embodiment of the present invention is shown. The ad hoc matching system 1000 generally includes a matching system server 1400 and an end user computing device (“source device”) 1200 both operatively coupled to a public network 1100, such as the Internet and/or a cellular-based wireless network. Optionally, the matching system 1000 further includes a location identification server 1500 (coupled to a global positioning system “GPS”), also operatively coupled to the public network 1100.

Turning to the matching system server 1400, an exemplary embodiment is shown in FIG. 1b. Generally, a matching system server 1400 includes a computer application designed to match subscribers to the system 1400 who have the potential to establish a successful interpersonal relationship. To obtain potential matches, each subscriber establishes a “match profile” that includes data and factors potentially relevant to establishing a successful interpersonal relationship with that subscriber. These factors can be organized into three major categories (1) physical attraction; (2) interpersonal interests and traits that are self-identified, such as hobbies and preferences; and (3) deep psychological traits, such as curiosity and interests that may not be self-identified. These factors are generated from empirical data collected from the subscriber, e.g., through questionnaires. An exemplary approach to establishing a match profile for a subscriber is described in detail in U.S. Pat. No. 7,454,357, issued to J. Galen Buckwalter et. al. on Nov. 18, 2008, which is hereby incorporated by reference in its entirety (“the Buckwalter patent”). These match profiles are stored in a match profile database 1410 and organized by the subscriber's match profile identification (“ID”). In the process of creating potential matches for a particular subscriber, a match engine 1420 queries the subscriber's matchprofile by its respective ID, and correlates that profile with other profiles to calculate a compatibility value. If two profiles generate a compatibility value that meets a predefined threshold, then there is potential for the two respective subscribers to have a satisfactory and/or successful interpersonal relationship if matched. Details of this calculation and correlation process are also described in the Buckwalter patent, which describes an exemplary compatibility value in the form of a “satisfaction index.”

Preferably, the match engine 1420 is configured to generate more than one compatibility value between two or more correlated match profiles, where each compatibility value is associated with a different type of relationship, e.g., dyadic, romantic, friendship, business, social, recreational, team oriented, long-term, or short term (e.g., minutes, hours, days, or months). Each type of relationship may involve the correlation of different factors and/or different weighting of factors from the various categories described above. For example, the prediction of a successful marriage between two subscribers may require the calculation of different factors as compared to the prediction of a successful business partnership or sports team. In yet another example, some relationships can be transitory, for example, two people sitting next to each other on a flight. In such an example, compatibility may not involve much analysis of the deep psychological traits and instead may be dictated by whether the individuals share a common tolerance for noise, which may not be as relevant for other types of relationships. The predicted success of each type of relationship may be defined by a “compatibility value threshold” from which to compare a calculated compatibility value.

Generally, as mentioned above, a subscriber will rely on the service 1400 to match the subscriber with someone potentially compatible. However, there may be situations where the subscriber desires the match service 1400 to perform a targeted and/or ad hoc correlation. For example, a subscriber may have the specific identity of one or more other subscribers and wishes to have the match service 1400 perform a correlation on those specific subscribers to assess whether there is potential compatibility in the one or more different types of possible relationships between the subscribers. To address this, the match server 1400, in a preferred embodiment, includes a receiver system 1430 that will receive the identifications of the match profiles that a subscriber wishes to correlate over the public network 1100. Further, the match server 1400 also includes a transmission system 1440 that will prepare the results of the requested correlation performed by the match engine 1420 and return the results back to the subscriber over the public network 1100.

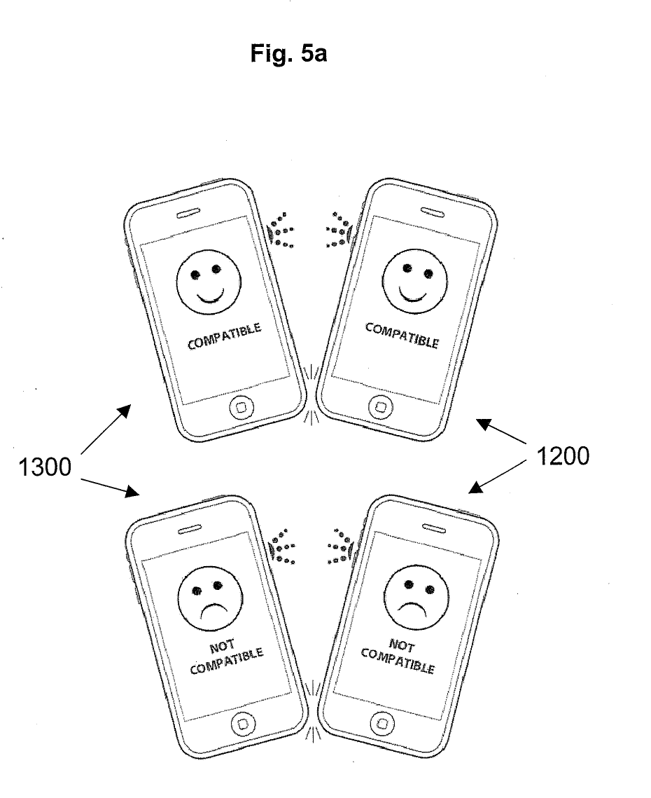

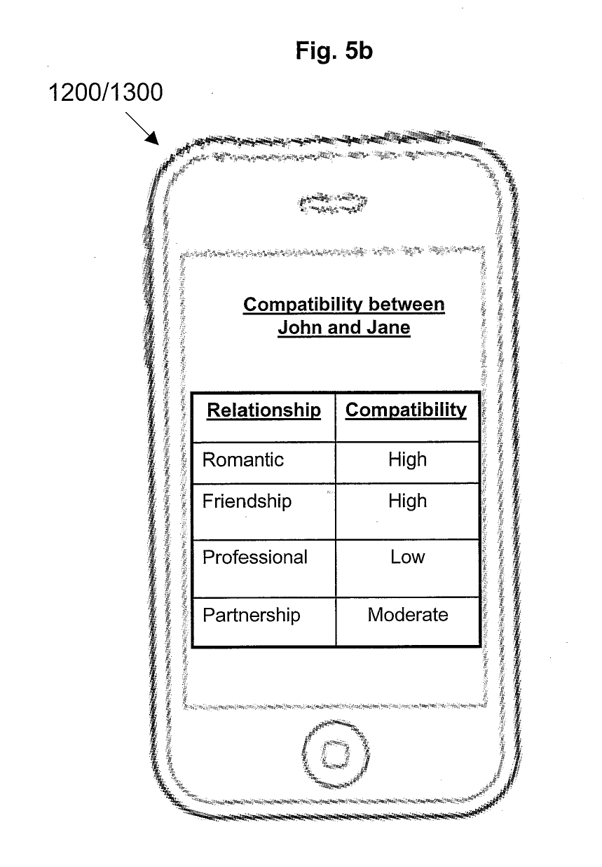

Turning to the end user computing device (“source device”) 1200, an exemplary embodiment is shown in FIG. 1c. The source device 1200, which can be any device with a processor, interface, and memory, such as a smart phone, tablet, cell phone, or personal computer, includes a computer application having several components. The source device 1200 first includes a match profile/compatibility transceiver 1210, which is configured to transmit to match server 1400 the identifications of the match profiles that the subscriber wishes to correlate and further configured to receive the results of the requested correlation. The match profile/compatibility transceiver 1210 is coupled to a database 1230 application configured to store both the identifications of the match profiles and the results of the requested correlation. The database application 1230 includes an interface that presents the results to the subscriber. Example interfaces are shown in FIGS. 5a and 5b. In FIG. 5a, the database application 1230, which can reside on both the source 1200 and target 1300 devices, will include an interface that indicates whether two or more profiles are “compatible” or “not compatible” based on the requested correlation. Turning to FIG. 5b, another example interface is shown, which also can reside on both the source 1200 and target 1300 devices. In this example, the results of multiple compatibility correlations are shown for different types of relationships, e.g., romantic, friendship-based, professional, and partnership-based relationships. If the value of a particular compatibility correlation far exceeds the corresponding threshold value, then the result is “high” compatibility. If the value nearly matches the threshold, then the result is “moderate.” If the value is lower than the threshold, then the result is “low.”

The source device 1200 can further include an ad hoc communicator 1220 coupled to the match profile/compatibility transceiver 1210 and/or database 1230. The ad hoc communicator 1220 is configured to communicatively connect to the computing device of one or more other subscribers (“target devices”) 1300 and 1350. The ad hoc communicator 1220 can then request the identification of the match profiles for the respective subscribers, said identification preferably stored on their respective computing devices 1300 and 1350 for automatic retrieval. In one preferred embodiment, the ad hoc communicator 1220 may be communicatively coupled to the location identification server 1500 (coupled to a global positioning system “GPS”), via the public network 1100. In this embodiment, the ad hoc communicator 1220 can request a data connection with a target device 1300 and 1350 based on the target device's physical location. For example, the ad hoc communicator 1220 can enable a data connection with a target device (1300 or 1350) that is physically within inches of the source device 1200. An example of a subsystem that enables such a connection is “Bump Validation,” which is described in U.S. application Ser. No. 12/699,692 to Andrew G. Huibers and is hereby incorporated by reference in its entirety (“the Huibers application”)

In an alternative embodiment, the source device 1200 and target device (1300 and/or 1350) can include data communication devices that enable short distance communications, e.g., Bluetooth, WiFi, and/or RFID technologies. These enable low powered and short distance data transmissions between devices and can be used by the ad hoc communicator 1220 to establish a data connection, enabling the retrieval of the target device's (1300 or 1350) match profile identification.

### Preferred Processes

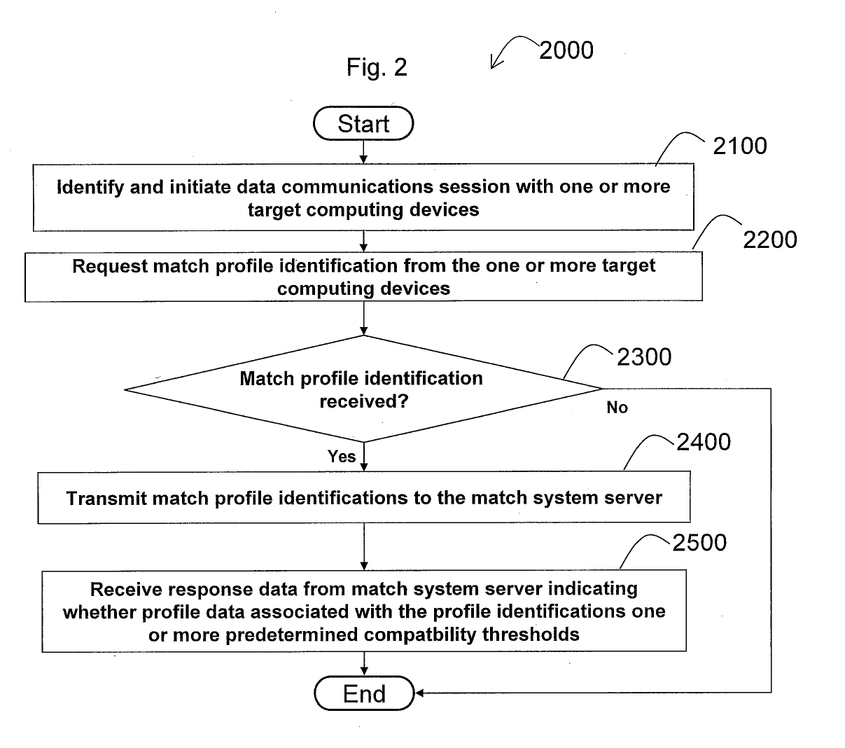

Turning to FIG. 2, a description of the operation of the ad hoc computer-based matching system 1000 is shown. If a first subscriber to the matching service 1400 identifies one or more second subscribers having a computing device (“target device” 1300 and/or 1350), the first subscriber may wish to initiate an ad hoc match correlation with the one or more second subscribers to assess whether there is any compatibility. This may arise when a first subscriber meets another subscriber at a social gathering, e.g., a party or a business-related function, or in a transitory gathering, e.g., a flight. The subscribers may wish to determine if they are compatible on a social or business level or some other criteria. In yet another example, the subscribers may be travelling on a long flight together, and there's an interest in assessing compatibility in seating arrangements.

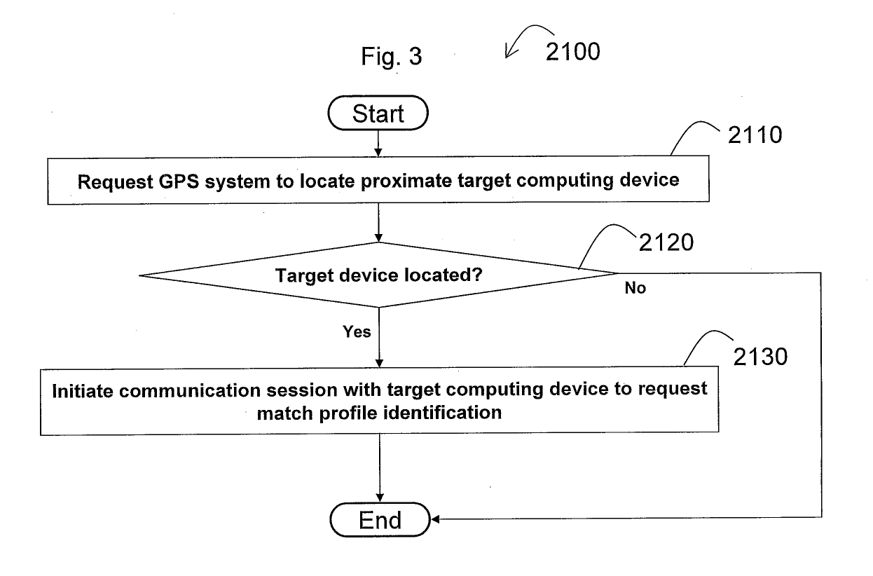

To achieve this ad hoc correlation, the first subscriber may attempt to retrieve the second subscribers' match profile identification. In doing so, the first subscriber's computing device (“source device”) 1200 can identify and initiate a data communications session with the second subscribers' computing device (“target device”) (1300 and/or 1350) (Action Block 2100). Turning to FIG. 3, a more detailed description of a preferred embodiment of this step is shown. The ad hoc communicator 1220 on the first subscriber's source device 1200 may request the location of the target device(s) (1300 and/or 1350) and request a communication session with the target device(s) (1300 and/or 1350), e.g., using the location identification server 1500 and its GPS system (Action Block 2110). As one of ordinary skill in the art will appreciate, one approach to achieving this is set forth in “the Huibers application.” With this implementation, the first subscriber can “bump” its source device 1200 with the target device(s) (1300 and/or 1350) to initiate a data exchange. Once the target device(s) (1300 and/or 1350) is located (Decision Block 2120), the communication session can be initiated to exchange data (Action Block 2130). In the alternative, close range communications technology may also be used, for example, RFID, Bluetooth or WiFi, to initiate the communications session.

Once the session is initiated, turning back to FIG. 2, the source device 1200 can submit an electronic request for the second subscribers' match profile ID stored on the target device(s) (1300 and/or 1350) (Action Block 2200). In yet another alternative, instead of having the source device 1200 identify the target device(s) (1300 and/or 1350), the first subscriber can use any information that identifies the second subscriber(s) on the network 1100, such as an email address, phone number, linkedin, Twitter, Facebook, or Skype account ID, to request the second subscribers' match profile ID.

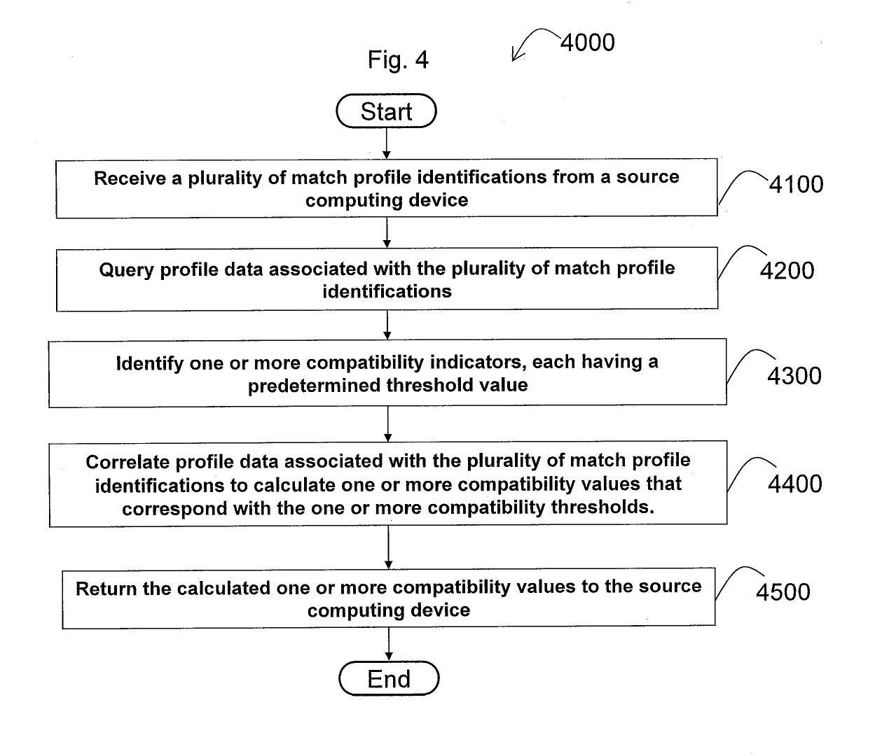

If the target device(s) (1300 and/or 1350) returns a match profile ID, (Decision Block 2300), then the source device 1200 will transmit the received match profile ID(s) (as well as the first subscriber's) to the match server 1400 (action block 2400), and request that the match server 1400 perform an ad hoc match correlation between the corresponding match profiles. Turning to FIG. 4, the operation of the preferred ad hoc match correlation 4000 performed by the match server 1400 is shown. When the match server 1400 receives the match profile IDs and the request for an ad hoc correlation between the profiles corresponding to the IDs via the match profile ID receiver 1430 (Action Block 4100), the match engine 1420 queries the match profile database 1410 for the respective profiles (Acton Block 4200), and further identifies one or more compatibility indicators, each corresponding to a different type of relationship and each having a predetermined threshold value (Action Block 4300). The identity of the indicators (or relationship types) can come from the subscriber's source device 1200 and/or all available indicators may be specified by default. The match engine 1420 then performs the correlation analysis, e.g., as set forth in the Buckwalter Patent (Action Block 4400), and the calculated compatibility values are transmitted back to the source device 1200, via the compatibility results transmitter 1440 (Action Block 4500). In an alternative embodiment, the match engine 1420 may reside on the subscriber device 1200, and thus, the match server 1400 would just return the corresponding profiles from its database 1410 so the ad hoc correlation can be performed on the source device 1200 itself. In yet another alternative embodiment, the match profile data may reside on the subscriber's and targets' computing devices, and therefore, if the subscriber's computing device contains a match engine 1420 as well, the ad hoc correlation may be achieved without a remote server.

Turning back to FIG. 2, the subscriber's computing device 1200 then receives and presents the compatibility results to the subscriber (Action Block 2500). For example, the subscriber's computing device 1200 (and 1300/1350) can present the results via the interfaces shown in FIGS. 5a and 5b.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for interpersonal relationships; however, the invention can be used for any relationship in general. Additionally and obviously, features may be added or subtracted as desired. Accordingly, the invention is not to be restricted except in light of the attached claims and their equivalents.

What is claimed is:

1. A computer-based system for enabling an ad hoc interpersonal relationship analysis, comprising:
a source computing device, operatively coupled to a public network, having a first match profile identification associated with said source computing device's user;
a target computing device, operatively coupled to the public network, having a second match profile identification associated with said target computing device's user; and
a matching server system, operatively coupled to the public network, having a database that stores match profile data associated with the first and second match profile identifications;
wherein the source computing device is configured to retrieve the second match profile identification from the target computing device and transmit the first and second match profile identifications to the matching server system via the public network; and
further wherein the matching server system is configured to receive the first and second match profile identifications via the public network from the source computing device;
query and correlate the match profile data associated with the first and second match profile identifications;
compute one or more compatibility values from the correlation of the match profile data associated with the first and second match profiles identifications; and
transmit said one or more compatibility values to the source computing device via said public network.

2. The computer-based system of claim 1, wherein the source and target computing devices are mobile wireless computing devices.

3. The computer-based system of claim 2, wherein the system further includes a location server system operatively coupled to the public network, and wherein the source computing device retrieves the second match profile identification from the target computing device by identifying the target computing device's location via the location server system and initiating a communications session with the target computing device.
